(19) United States
(12) Patent Application Publication
(10) Pub. No.: US 2004/0182897 A1
(43) Pub. Date: Sep. 23, 2004

(54) Device for securely and conveniently holding electronic devices in a golf cart

(76) Inventors: Mark D. Andrews, Stevenson Ranch, CA (US); Charles J. Collins, Valencia, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/802,466

(22) Filed: Mar. 16, 2004

Related U.S. Application Data
(60) Provisional application No. 60/455,696, filed on Mar. 17, 2003.

(51) Int. Cl. B65D 25/52; A01K 97/04; A01K 97/06; B60R 9/00; B60R 7/06

(52) U.S. Cl. 224/274; 224/483

(57) ABSTRACT

A device for securing and conveniently holding an electronic device, such as a cell phone, in a golf cart includes a holster adapted to removably receive a clip of the electronic device. Preferably, the holster includes upper and lower apertures adapted to receive a portion of an alligator clip of the electronic device therethrough, as well as an open-ended slot on the face thereof which is adapted to receive a swivel on the electronic device therein. An anchor is attached to the holster and is adapted to be inserted into a golf ball holding compartment of the golf cart for securely supporting the device and electronic apparatus relative to the golf ball holding compartment. Typically, the anchor is a semi-spherical cradle configured to hold a golf ball therein, which together frictionally hold the device within the golf ball holding compartment of the golf cart.

### RELATED APPLICATION

This application claims priority to U.S. Patent Application Serial No. 60/455,696, filed on Mar. 17, 2003.

### BACKGROUND OF THE INVENTION

The present invention generally relates to clips and other devices for securingly holding electronic devices, such as mobile phones and the like. More particularly, the present invention is concerned with a device for securely holding such electronic devices in a golf cart.

In this day and age, most people carry an electronic device, such as a portable music player, a pager, a PDA or a mobile or cell phone. Particularly in the case of cell phones, these devices are nearly constantly carried so as to enable the person to be in contact with friends, family and business associates as needed. Clips and other devices have been devised so that such cell phones and other electronic devices can be conveniently attached to a belt of the individual to provide unimpeded access.

Typically, such clips are of two varieties. The first comprises an alligator-type clip wherein the clip is pivoted to an open position and slipped over a belt or top edge of one's pants. The cell phone is then held in place until a call is to be made or received. Depending upon the type of clip, the entire assembly of phone and clip can be removed, or the phone can be removed from the clip assembly itself to make and receive telephone calls. Another common attachment means comprises a swivel clip wherein a generally circular protrusion extends from a back plate of the cell phone and which is removably inserted into a mating slot or aperture of the holder. Such clips allow the user to bend over and move around without dislodging the phone.

However, such clips do not provide the requisite convenience when the individual is golfing. Many golfers do not like to wear the phone as it becomes a distraction. The clips and phone attached to the side of the golfer can inhibit the golfer's movement during the swings required to strike the golf ball. There also exists the possibility that the phone may become dislodged and fall to the ground, possibly breaking the phone.

Instead of wearing the phone, some golfers leave it in the golf bag. However, leaving it in the golf bag makes it difficult to check for missed calls or even retrieve the phone in a timely manner to receive calls. Some golf courses are beginning to require golfers to turn off the ringing portion of the phone so that other golfers nearby are not distracted. Of course, placing the phone on vibration mode will not alert the user to incoming calls when the phone is in the golf bag.

Others place the phone in the golf cart's cup holder or “glove compartment”. However, it has been found that the phone can become scratched as it slides around in such compartments while the golf cart is driven. Moreover, the phone is hidden from view and oftentimes is forgotten after the round of golf.

A cell phone holder specifically designed for golf carts is available. It utilizes the cup holder of the golf cart for its base. However, this product is not very convenient due to its size, about eight inches tall, and is difficult to fit into a golf bag. The cell phone holder is also fairly complicated in nature in that the golfer must tighten the base of the device to the cup holder, and then adjust spring-loaded wings which hold the cell phone. The space in between the spring-loaded wings limits the types of electronic devices which can be held by this device. Also, due to the mechanical complexity of the holder, it is quite expensive as it retails for approximately thirty dollars.

Accordingly, there is a continuing need for a holder or attachment device for cell phones and other electronic devices for specific use in a golf cart while golfing. The present invention overcomes the drawbacks discussed above and provides many other related advantages.

### SUMMARY OF THE INVENTION

The present invention resides in a device which securely and conveniently holds electronic devices, such as cell phones, in a golf cart such that the cell phone or other electronic device is easily within view and can be easily removed from the device for receiving or placing a call or the like. The device of the present invention is relatively inexpensive and simple in design and is small so as to be easily stored within one's golf bag.

The device generally comprises means for releasably holding an electronic device and an anchor attached to the holding means which is adapted to be inserted into the golf ball holding compartment of the golf cart for securely supporting the holding means and electronic device relative to the golf ball holding compartment.

The holding means in a particularly preferred embodiment comprises a holster adapted to removably receive a clip extending from the electronic device. In such particularly preferred embodiment, the holster includes spaced apart upper and lower apertures which are adapted to receive a portion of an alligator clip for the electronic device therethrough. Alternatively, or typically in addition to, the holster includes an open-ended slot formed in a face thereof which is adapted to receive a swivel clip of an electronic device therein.

The anchor typically comprises a cradle which is configured to hold a ball which together with the cradle frictionally fits within the golf cart ball holding compartment. Typically, the cradle is semi-spherical in configuration to removably hold a golf ball therein. The cradle may include inwardly projecting ribs adapted to engage the ball to secure it thereto. Preferably, the cradle includes a slot in a bottom portion thereof through which the ball partially extends, and side notches form therein through which opposing sides of the ball extend. This enables opposing sides of the ball to be frictionally fit within the golf ball holding compartment and hold the device securely relative to the golf ball holding compartment.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective environmental view depicting an electronic device holder embodying the present invention secured within a golf ball holder compartment of a golf cart and supporting a cell phone therein;

FIG. 2 is a front perspective view of the device of the present invention;

FIG. 3 is a top perspective view of the device of FIG. 2;

FIG. 4 is a cross-sectional view taken generally along line 4-4 of FIG. 3 illustrating a ball in phantom therein and pressure points for securing the device within a golf ball holder compartment of a golf cart;

FIG. 5 is a side elevational view of the electronic device holder of the present invention having a golf ball inserted therein and supporting a cell phone having a swivel clip extending therefrom;

FIG. 6 is a side elevational view similar to FIG. 5, but illustrating attachment of a cell phone having an alligator clip extending therefrom;

FIG. 7 is a side elevational view illustrating the electronic device holder of the present invention holding a cell phone and securely disposed within a golf cart golf ball holder compartment; and

FIG. 8 is a side elevational view similar to FIG. 7 illustrating the device secured within a different type of golf ball holder compartment of a golf cart.

### DETAILED DESCRIPTION OF THE PREFERRED EMBODIMENTS

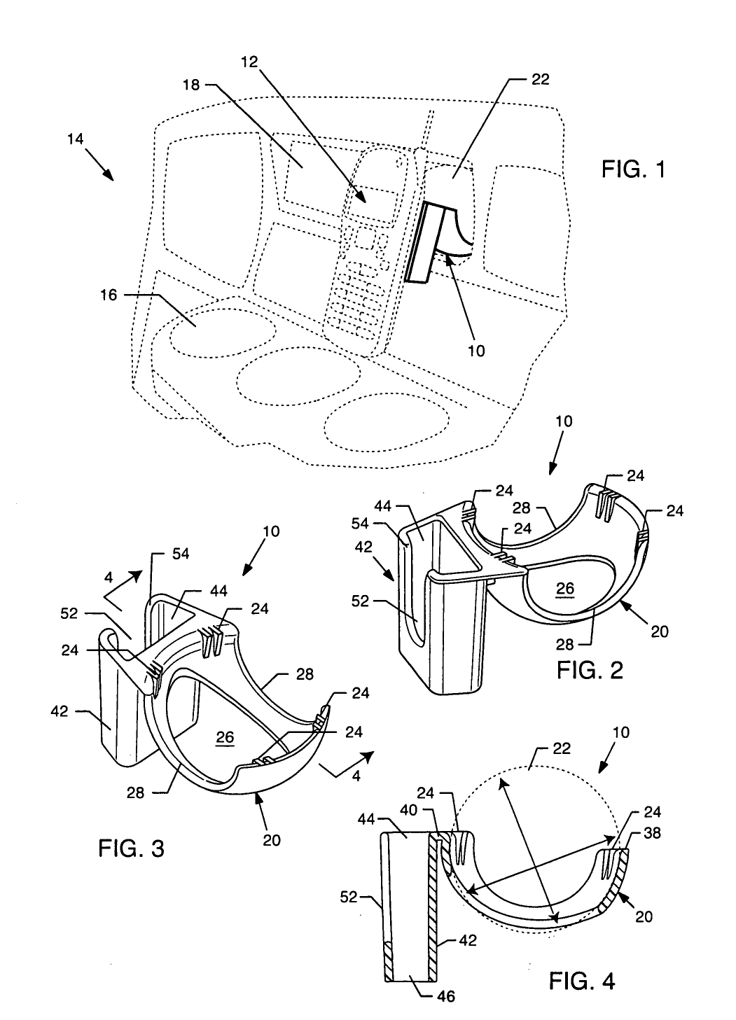

As shown in the accompanying drawings for purposes of illustration, the present invention resides in a device, generally referred to by the reference number 10, which is designed to securely and conveniently hold an electronic device 12, such as a cell phone or the like, in a golf cart 14. As is well known in the art, a golf cart in the front passenger area thereof includes a dashboard area adjacent to the steering wheel area. Within the steering wheel area are typically formed cup holders 16 for holding ones beverage while golfing, and a compartment 18 which is configured to hold a plurality of golf balls therein for easy access by the golfer, yet designed to retain the golf balls therein even during rough riding conditions. Such golf ball compartment 18 are typically formed in a front face of the golf cart dashboard as an elongated recess into the dashboard, as illustrated in FIG. 1. The device 10 of the present invention utilizes such golf ball compartment 18 to position and securely hold the electronic device 12 relative thereto to be easily viewed and retrieved by the golfer.

With reference now to FIGS. 2-4, the device 10 includes an anchor 20. The anchor is configured and designed so as to be removably inserted within the golf ball compartment 18 of the golf cart 14. The present invention contemplates any such configuration which would be capable of removable engagement With the golf ball compartment 18, including a golf ball-shaped anchor, or any other geometrical shape which could be frictionally fitted within the golf ball compartment 18.

In the particularly preferred embodiment which is illustrated, the anchor 20 comprises a semi-spherical cradle 20 which is designed to removably hold a ball, typically a golf ball, therein. The cradle 20 is cup-shaped so that the golf ball 22 is inserted therein. Inwardly projected ribs 24 frictionally engage the golf ball securely in place within the cradle.

In a particularly preferred embodiment, the cradle 20 includes a slot 26 formed in a bottom portion thereof, which is sized and designed such that a lower portion of a golf ball will extend therethrough, as illustrated in FIG. 4. Opposing side notches 28 are also formed in the cradle 20 so that opposing side of the golf ball 22 extend slightly on either side of the cradle 20.

The elongated oval slot 26 and notches 28 are designed to maintain the size of and shape of the golf ball 22 and points of frictional pressure within the golf ball holding compartment 18 of the golf cart 14. This maintains the shape of the golf ball holder of the compartment 18 such that other golf balls placed in the golf cart holder do not become loose and fall out during rough riding conditions. The oval slot 26 maintains the vertical height of the golf ball 22 and enables the golf ball to have upper and lower pressure points, illustrated as a vertical arrow in FIG. 4. This enables the golf ball 22 to frictionally engage upper and lower surfaces of the golf ball holder compartment 18 as illustrated in FIG. 1. With reference to FIG. 7, in some golf ball compartment holders 18, a flexible inner lip 30 is resiliently flexible so as to receive the golf ball 22 therein and frictionally hold them until removed by the golfer. Due to the fact that the golf ball 22 extends through the slot 26, pressure points on the golf ball are maintained at a lower surface 32 of the golf ball holding compartment 18 and the flexible lip 30 such that the golf ball 22 and cradle 20 are securely held within the golf ball holding compartment 18.

With reference to FIG. 8, another golf ball holding compartment design is illustrated wherein the golf balls 22 are frictionally held between a ridge or protruding knob 34 and a front ledge 36 of the golf ball compartment holder 18. The slot 26 formed in the cradle 20 is preferably sufficiently long so that the golf ball 22 maintains pressure points between the protruding ridge 34 and front ledge 36, as illustrated with the directional arrow in FIG. 8. Outer surfaces of the cradle 20 may also be in frictional engagement with the front ledge 36, bottom surface 32 or other surfaces of the golf ball holding compartment 18 so as to increase the frictional engagement therewith.

In a particularly preferred embodiment, the overall size of the device 10 of the present invention is approximately 1.5 inches in height and 2.5 inches in overall length. In such instance, the width of the oval slot 26 is slightly less than 1 inch and the length of the slot 26 is approximately 1.5 inches, although these dimensions can be altered as needed. It has been found that a sufficiently wide slot 26 prevents the device 10 from rocking side to side which it might otherwise do when driving the golf cart 14 along rough terrain.

With reference to FIG. 4, it will be noted that a front lip 38 of the cradle 20 does not extend to the full height of the back lip 40, instead being slightly shorter than the back lip 40. With the dimensions provided above in the particularly preferred embodiment, the front lip 38 would be approximately 0.20 inches lower than the back lip 40. Such offset facilitates the anchoring of the cradle 20 within golf ball holding compartments 18 of the type illustrated in FIG. 8. That is, due to the shortened height of lip 38, the golf ball pressure point can be established with the ridge 34 immediately above the front lip 38. Moreover, offsetting the height of the lips 38 and 40 positions the electronic device 12 at a slight angle, as illustrated in FIGS. 1, 7 and 8, which presents the display of the electronic device 12 at a pleasant and convenient viewing angle relative to the golfer.

With reference again to FIGS. 2-4, the device 10 also includes means for releasably holding the electronic device 12, typically in the form of a holster 42. A holster 42 is adapted to receive a clip or protrusion extending from the electronic device 12.

As illustrated, the holster 42 is generally in the shape of a hollow box. The holster includes upper and lower apertures 24 and 46 through which an alligator clip 48, or the like can be inserted, as illustrated in FIG. 6. The height of the holster 42 is designed to accommodate various types alligator clips 48. As discussed above, many electronic devices, particularly cell phones, include such alligator clips 48 for direct attachment of the cell phone 12 or other electronic device to the user's belt or a carrying case attached to the belt of the user. The golfer can simply remove the electronic device 12 and insert the clip 48 into the upper aperture 44, such that it extends through the holster 42 and out of the lower aperture 46 for securely engaging and attaching the electronic device 12 to the holster 42.

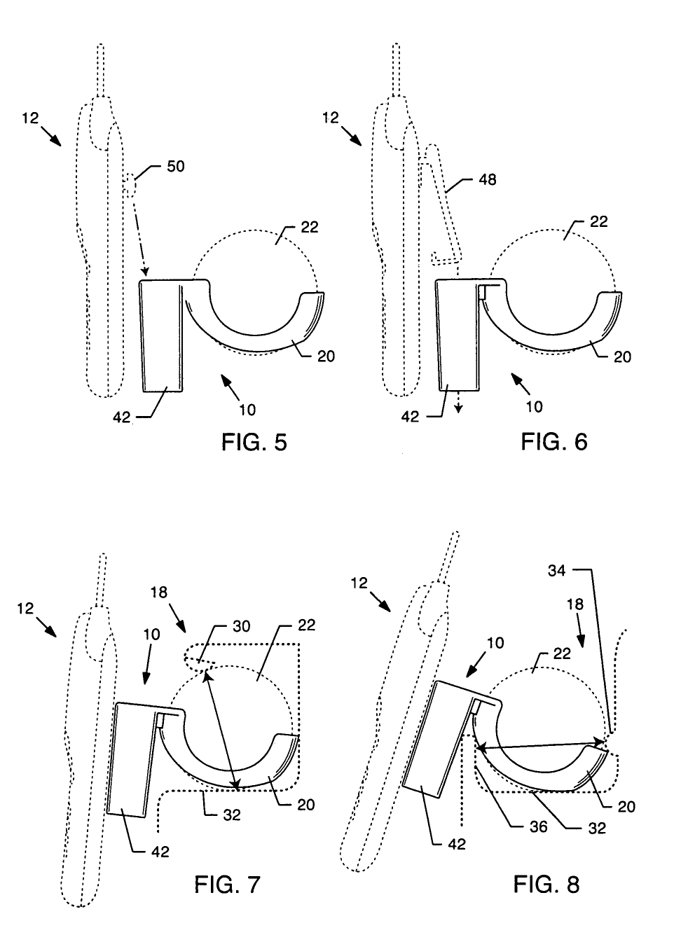

With reference now to FIGS. 2 and 5, another means of attaching cell phones and electronic devices 12 to a user is via a swivel clip 50 wherein a swivel protrusion extends from the electronic device or a carrying case thereof for mating relationship to a carrying case attached to the user's belt or the like. The holster 42 of the present invention accommodates such swivel clips 50 by including an open-ended slot 52, typically in a front face thereof. This notch or slot 52 preferably includes rounded edges 54 and a greater width at an upper end thereof to facilitate placement of the swivel clip 50 therein. The notch or slot 52 decreases in width along the length thereof and is sufficiently deep such that the electronic device 12 will not be dislodged due to rough driving of the golf cart. Typically, most swivel phone clips have a mechanism for securing the swivel clip 50 within the notch on the user's carrying case attached to his or her belt such that the phone or other electronic device will not become dislodged as the user bends over and moves around. Although the present invention could incorporate such a mechanism, it has been found to be not necessary as the depth and width of the slot 52 sufficiently engages the swivel clip 50 for secure enough attachment for golf cart driving and thus simplifies the design of the device 10 and reduces its manufacturing cost.

Although the anchor or cradle 20 and holster 42 have been described as separate members of the device 10, in a particularly preferred embodiment, the entire device 10 is formed as a unitary structure, such as by plastic injection molding or the like. This enables the device 10 to be manufactured quite inexpensively. It will also be appreciated by those skilled in the art that the device 10 provides easy access to the electronic device 12 when in the golf cart. The golfer can easily view the display of the electronic device 12 to see if any incoming messages or calls need to be responded to. If so, the electronic device 12 can be easily removed from the holster 42 from the device 10 to place a call, receive a message, etc. and then returned to the holster 42 of the device 10 which remains within the golf ball holding compartment 18 of the golf cart 14. As the electronic device 12 is highly visible when leaving the golf cart 14, there is very little chance of losing the electronic device 12. As discussed above, the overall size of the device 10 is sufficiently small so as to be conveniently placed within a pocket of the golf bag when not in use. Given the simple design and nature of the device 10, it can be purchased for much less than prior art cell phone holding devices and is much easier to use.

Although several embodiments have been described in some detail for purposes of illustration, various modifications may be made without departing from the scope and spirit of the invention. Accordingly, the invention is not to be limited, except as by the appended claims.

What is claimed is:

1. A device for securing and conveniently holding an electronic device in a golf cart having a golf ball holding compartment, the device comprising:
means for releasably holding an electronic device; and
an anchor attached to the holding means and adapted to be inserted into the golf ball holding compartment of the golf cart for securely supporting the holding means and electronic device relative to the golf ball holding compartment.

2. The device of claim 1, wherein the anchor comprises a cradle configured to hold a ball therein sized to frictionally fit within the golf ball holding compartment.

3. The device of claim 2, wherein the cradle is semi-spherical in configuration to removably hold a golf ball therein.

4. The device of claim 2, wherein the cradle includes a slot in a bottom portion thereof through which the ball partially extends.

5. The device of claim 2, wherein the cradle includes inwardly projecting ribs adapted to frictionally engage the ball.

6. The device of claim 2, wherein the cradle includes side notches formed therein through which opposing sides of the ball extend.

7. The device of claim 1, wherein the holding means comprises a holster adapted to removably receive a clip of the electronic device.

8. The device of claim 7, wherein the holster includes spaced apart upper and lower apertures adapted to receive a portion of an alligator clip therethrough.

9. The device of claim 7, wherein the holster includes an open-ended slot formed in a face thereof adapted to receive a swivel clip therein.

10. A device for securing and conveniently holding an electronic device in a golf cart having a golf ball holding compartment, the device comprising:
a holster adapted to removably receive a clip of the electronic device; and
an anchor attached to the holster and adapted to be inserted into the golf ball holding compartment of the golf cart for securely supporting the holster and electronic device relative to the golf ball holding compartment.

11. The device of claim 10, wherein the anchor comprises a cradle configured to securely hold a ball therein for frictional fit within the golf ball holding compartment.

12. The device of claim 11, wherein the cradle is semi-spherical in configuration to removably hold a golf ball therein.

13. The device of claim 11, wherein the cradle includes a slot in a bottom portion thereof through which the ball partially extends.

14. The device of claim 11, wherein the cradle includes inwardly projecting ribs adapted to frictionally engage the ball.

15. The device of claim 11, wherein the cradle includes side notches formed therein through which opposing sides of the ball extend.

16. The device of claim 10, wherein the holster includes spaced apart upper and lower apertures adapted to receive a portion of an alligator clip therethrough.

17. The device of claim 10, wherein the holster includes an open-ended slot formed in a face thereof adapted to receive a swivel clip therein.

18. A device for securing and conveniently holding an electronic device in a golf cart having a golf ball holding compartment, the device comprising:
a holster including spaced apart upper and lower apertures adapted to receive a portion of an alligator clip of the electronic device therethrough, and an open-ended slot formed in a face thereof adapted to receive a swivel clip of the electronic device therein; and
an anchor including a cradle attached to the holster and adapted to securely receive a ball therein for frictional insertion into the golf ball holding compartment of the golf cart for securely supporting the holster and electronic device relative to the golf ball holding compartment.

19. The device of claim 18, wherein the cradle includes a slot in a bottom portion thereof through which the ball partially extends.

20. The device of claim 18, wherein the cradle includes inwardly projecting ribs adapted to frictionally engage the ball.

21. The device of claim 18, wherein the cradle includes side notches formed therein through which opposing sides of the ball extend.
